(19) United States
(12) Patent Application Publication
(10) Pub. No.: US 2005/0080763 A1
(43) Pub. Date: Apr. 14, 2005

(54) Method and device for development of software objects that apply regular expression patterns and logical tests against text

(76) Inventor: Benjamin Sheldon Opatowski, Springfield, NJ (US)

Correspondence Address: Benjamin Sheldon Opatowski, 154 New Brook Lane, Springfield, NJ, 07081, US

(21) Appl. No.: 10/962,784

(22) Filed: Oct. 12, 2004

Related U.S. Application Data
(60) Provisional application No. 60/509,845, filed on Oct. 9, 2003.

(51) Int. Cl. G06F 7/00

(52) U.S. Cl. 707/1

(57) ABSTRACT

The invention teaches an integrated and dedicated log monitoring object development environment which teaches use of regular expressions, logical expressions, and the truth states of those regular expressions, and also allows self-testing of the objects as they are developed. The invention teaches that a five step process may be used to create log monitoring software objects. In a first step, identifier/regular expressions may be added to the object from a list or menu or manually entered. In a second step, a line pattern is established by ordering the identifiers. In a third step, logical expressions are constructed in accordance with a logical expression grammar; in a fourth step, an action item to invoke upon a “true” value is associated with the logical expression. In the fifth step, a file to be monitored is selected, along with file attributes such as offset position and EOF disposition.

### CROSS-REFERENCE TO RELATED APPLICATIONS

This application claims the priority and benefit of U.S. Provisional Application No. 60/509,845 filed Oct. 9, 2003 in the name of the same inventor, Benjamin Sheldon Opatowski, and entitled METHOD AND PROCESS FOR DEVELOPMENT AND IMPLEMENTATION OF A SOFTWARE OBJECT INSTANCE THAT APPLIES REGULAR EXPRESSION PATTERNS AND LOGICAL TESTS AGAINST TEXT, the disclosure of which is incorporated herein by this reference thereto.

### FIELD OF THE INVENTION

This invention relates generally to software devices and specifically to management of event messages in a computer system by means of software objects.

### STATEMENT REGARDING FEDERALLY FUNDED RESEARCH

This invention was not made under contract with an agency of the US Government, nor by any agency of the US Government.

### BACKGROUND OF THE INVENTION

A computer system and the applications running thereon generate event messages during the operations of the system. Such event messages are mostly short lines of text.

In general, such event messages are then placed into log files which record long sequences of such messages. In many home computers, such event logs are never even examined, while in some large enterprise environments, teams of human system operators are dedicated to monitoring them, although software exists to automate the log monitoring function.

Examples of such log monitoring software packages include IBM's Tivoli software suite (which includes among many other utilities a log monitor component) and Nagio, a free software suite for log monitoring.

However, these suites have certain undesirable features to them. First, there is a frustration cost and time barrier to overcome for the typical programmer in becoming conversant in these suites. In the case of all encompassing packages like Tivoli, they include numerous features which render them more complex and thus actually more difficult to use. It would be preferable to provide dedicated log monitoring tool development environments.

Second, these suites are not necessarily truly “integrated” development environments as far as the log monitoring components are concerned. It would-be preferable to provide a dedicated log monitoring development environment which is truly integrated.

Third, these suites do not necessarily allow easy use of regular expressions and logical expression evaluations for the monitoring use nor do they support construction of software object instances to monitor logs. It would be preferable to provide a simple programming process to allow construction of log monitoring objects. Related to this issue is the fact that these systems do not allow self-testing of the monitoring components as they are developed, so that outcomes (truth states) of example events may be examined and verified to match programmer expectations, as in a truly integrated development environment. Thus as a fourth matter, it would be preferable to provide an integrated programming environment for log monitoring objects that allows self-testing of the component parts as the programming proceeds.

Generally, it may be stated that if the events generated from the computer systems inside an enterprise are recognized and mapped to responses, business efficiencies increase. Operational anomalies from service daemons or system applications could be quickly remedied because of early discovery. Events originating from different sources but logically related could be identified and stored with regard to category. Subsequent analysis could then initiate responses of various types, like email and beeper alerts.

### SUMMARY OF THE INVENTION

General Summary

The invention teaches an integrated and dedicated log monitoring object development environment that utilizes regular expression matching and logical expression truth states to qualify messages. It also supports the self-testing of many of the object's components as they are developed.

The invention also teaches that a straightforward five step process may be used to create log monitoring software objects. In a first step, regular expressions may be added to the object from a list or entered manually, and tagged with a name called an identifier. In a second step, a line pattern is established by ordering the identifiers that were entered into the regular expressions step in a sequence in which their associated regular expressions will match the character groups of a targeted message. In a third step, one or more logical expressions are formed according to a grammar with each logical expression containing a subset of the identifiers that comprise the line pattern. As expected, a logical expression yields either true or false when evaluated.

In a fourth step, action items like C/C++ shared object library functions, or Java applications or command scripts (e.g. emails, pager alerts, database transactions) or combinations thereof are associated with a logical expression and summarily executed when the logical expression evaluates to true. In an alternative embodiment, in addition to the aforementioned actions, the action may include a changing to another line pattern. In the fifth step, a file to be monitored is selected along with its I/O attributes of selecting a file offset and EOF mode.

The types of files that may be monitored are unlimited, because a line pattern can be formed for any log format or file, and further because any arbitrary byte-sized bit pattern can be recognized by a regular expression either in octal notation (like ‘\ooo’ where ooo is one to three octal digits) or hex notation (like ‘\xhh’ where hh is one or more hex digits), so file format is not a limitation. Typical log files include MySQL, Apache, Samba, Sendmail, Linux/UNIX security logs, and application instrumentation logs.

It would be preferable to provide a platform independent object by which a log monitoring instance created on one type of system (i.e. Linux) is reconstructed automatically relative to a new host environment (i.e. Solaris) as is with this software invention.

Uniquely, it is possible to test most of the attributes of the instance being created in their respective tab panels: testing regular expressions for validity and for pattern matches against sample input, pattern matching testing of the line pattern against ten or less lines of sample input, test evaluation of logical expressions against ten or less lines of sample input, testing that a Java action item is an application, and testing that a C/C++ shared object library contains the function that was entered in the Shared Library Function Name text input box.

Restated, the invention will allow a user easy creation of an object instance (in which the object is a “message and event monitoring object” or “MEMO” for short) that will recognize and logically evaluate lines of text and respond by invoking action items. An object (or MEMO instance) is created through the invention's graphic user interface/integrated development environment. It should be noted that text recognition and logical evaluation may encompass the entire event message or portions thereof. If the matching criteria are met, response actions termed, here as action items, are invoked as a result. They are encapsulated within the object instance as the actual action item (like a simple command itself) or as a reference to a set of action items (like the name of a command script). They can be numerous and varied including: emails, pager calls, database transactions, C/C++ shared library functions, other shared library functions, Java applications, executable objects, telephony devices, database transactions and combinations thereof.

The MEMO software object entity is created via the overall device of the invention, the GUI/IDE. The GUI/IDE very importantly provides for a logical, sequenced approach to building the MEMO instance, especially including test facilities on several of its tabs that verify the results the user expects from the input that was just rendered.

The GUI/IDE incorporates test facilities on the Regular Expression, Line Pattern, and Logical Expression tab panels that verify the results the user expects from the input that was just rendered, which may be text strings in the regular expressions tab panel or event messages in the line pattern and logical expression tab panels. Maddening, time consuming, expensive and potentially disastrous logic and expression errors are thus reduced.

Thus the GUI/IDE very importantly provides for a logical, sequenced approach to building the MEMO instance. When a new MEMO instance is created, only the Regular Expression tab panel is accessible. As input requirements are satisfied, the next MEMO tab in the sequence becomes available. For example, after defining at least one identifier/regular expression pair in the Regular Expression tab panel, the Line Pattern tab panel becomes input enabled. At this point, the tab panels which succeed the Line Pattern tab panel—Logical Expressions, Actions Items and the Input Settings—are still input disabled, stippled. As inputs are entered, that is attribute values are assigned to the instance, and successive tab panels are input enabled. After one or more tab panels are ‘opened’ an antecedent tab panel may be accessed. If a change to the antecedent tab is made that adversely affects its succeeding tab panel, an error will be reported. The Input Settings tab panel contains a FINISH push button. Pressing it validates all the inputs on this tab panel, initiates a dialog to determine if the instance should be stored to disk, and disallows further changes to the instance by disabling (stippling) all the five tab panels.

### SUMMARY IN REFERENCE TO CLAIMS

It is therefore a first aspect, advantage, objective and embodiment of the invention to provide a log monitoring software object creation integrated development device for use on a computer having a file system, the device comprising:

i) a regular expression designation module having a regular expression sample list and a first utility allowing designation of at least one regular expression, and having a first test module allowing validation of a first test string with the selected regular expression;

ii) a line pattern module having a display of the selected regular expressions and having a second utility allowing designation of the selected regular expressions into a line pattern, and having a second test module allowing validation of a first test message with the line pattern;

iii) a logical expression designation module having a sample logical expression list and a display of the line pattern elements, and having a second utility allowing association of at least one logical expression to examine at least one regular expression in the line pattern, and having a third test module allowing validation of a message with the logical expression.

It is therefore a second aspect, advantage, objective and embodiment of the invention to provide a log monitoring software object creation integrated development device further comprising:

iv) an action item selection module having an entry form allowing users to enter at least one action item to be activated upon return of a logical value by the logical expression.

It is therefore another aspect, advantage, objective and embodiment of the invention to provide a log monitoring software object creation integrated development device wherein the at least one action item further comprises one member selected from the group consisting of: executable objects, Java applications, C/C++ shared library functions, other shared object libraries, email software, paging devices, telephony devices, database transactions and combinations thereof.

It is therefore another aspect, advantage, objective and embodiment of the invention to provide a log monitoring software object creation integrated development device further comprising:

v) an input settings module displaying the computer's file system and allowing user navigation of the computer's file system and allowing user selection of a file to be monitored.

It is therefore another aspect, advantage, objective and embodiment of the invention to provide a log monitoring software object creation integrated development device wherein the step v) further comprises: allowing selecting of monitoring of the file to be monitored from its beginning.

It is therefore another aspect, advantage, objective and embodiment of the invention to provide a log monitoring software object creation integrated development device wherein the step v) further comprises: allowing selecting of monitoring of the file to be monitored from its end.

It is therefore another aspect, advantage, objective and embodiment of the invention to provide a log monitoring software object creation integrated development device wherein the step v) further comprises: selecting monitoring of the file to be monitored to terminate when an end of file is encountered.

It is therefore another aspect, advantage, objective and embodiment of the invention to provide a log monitoring software object creation integrated development device wherein the recurrent monitoring consists of tailing the file.

It is therefore another aspect, advantage, objective and embodiment of the invention to provide a log monitoring software object creation integrated development device further comprising a help module offering users one member selected from the group consisting of: samples of code for log monitoring software objects, explanations, action item codes samples and combinations thereof.

It is therefore another aspect, advantage, objective and embodiment of the invention to provide a log monitoring software object creation integrated development device wherein at least one selected regular expression has associated therewith an identifier, and further wherein use of the identifier in a line pattern operates as use of the regular expression associated therewith.

It is therefore another aspect, advantage, objective and embodiment of the invention to provide a log monitoring software object creation integrated development device further comprising one utility selected from the group consisting of: a regular expression add utility, a regular expression deletion utility, a regular expression editing utility; an identifier deletion utility; a logical expression deletion utility; a logical expression editing utility, a line pattern add utility, a line pattern deletion utility, a line pattern edit utility, an action item addition utility, an action item deletion utility, and an action item edit utility, and combinations thereof.

It is therefore yet another aspect, advantage, objective and embodiment of the invention to provide a method of programming a log monitoring software object comprising:

i) designating at least one regular expression;

ii) displaying the selected regular expression;

iii) ordering of the selected regular expression into a line pattern;

iv) displaying the line pattern;

v) selecting at least one logical expression;

vi) associating the logical expression with at least one selected regular expression;

vii) entering at least one action item to be invoked in the event of a “true” return of the logical expression; and

viii) selecting a file to be monitored.

It is therefore yet another aspect, advantage, objective and embodiment of the invention to provide a method of programming a log monitoring software object wherein the at least one action item further comprises one member selected from the group consisting of: executable objects, Java applications, C/C++ shared library functions, other shared object libraries, email software, paging devices, telephony devices, database transactions and combinations thereof.

It is therefore yet another aspect, advantage, objective and embodiment of the invention to provide a method of programming a log monitoring software object further comprising one member selected from the group of steps consisting of:

i-b) selecting the regular expression from a list;

i-c) manually entering the regular expression; and

i-d) combinations thereof.

It is therefore yet another aspect, advantage, objective and embodiment of the invention to provide a method of programming a log monitoring software object further comprising one member selected from the group of steps consisting of:

ii-b) validating a first test string with the regular expression;

iv-b) validating a first test message with the line pattern;

vi-b) validating a message with the logical expression;

and combinations thereof.

It is therefore yet another aspect, advantage, objective and embodiment of the invention to provide a method of programming a log monitoring software object further comprising one member selected from the group of steps consisting of:

vi-b) displaying the computer's file system; and

vi-c) navigating the computer's file system.

It is therefore yet another aspect, advantage, objective and embodiment of the invention to provide a method of programming a log monitoring software object further comprising one member selected from the group of steps consisting of:

vii-b) displaying the computer's file system; and

vii-c) navigating the computer's file system.

### BRIEF DESCRIPTION OF THE DRAWINGS

FIG. 1 is a block diagram of the device of the invention.

FIG. 2 is a flow chart of the method of the invention.

FIG. 3 is a screen shot of a first module of the invention, showing the module providing regular expression selection.

FIG. 4 is a screen shot of a second module of the invention, showing creation of a line pattern.

FIG. 5 is a screen shot of a third module of the invention, allowing the user to add logical expressions.

FIG. 6 is a screen shot of a fourth module of the invention adding an action item.

FIG. 7 is a screen shot of a fifth module of the invention, the designation of the log file to be evaluated.

FIG. 8 is a screen shot of a sixth help module of the invention.

FIG. 9 is a screen shot of the “OBJECT” menu in use in the invention.

FIG. 10 shows the “ACTIVITY” menu of the present invention.

### INDEX OF REFERENCE NUMERALS

Regular Expressions Module 100

Line Pattern Module 200

Logical Expressions Module 300

Action Items Module 400

Input Settings Module 500

Help Module 600

Selecting from a regular expression sample list a regular expression step 702

Validating of a first test string with the selected regular expression step 704

Displaying the selected regular expression step 706

Ordering of the selected identifiers into a line pattern step 708

Validating event messages in the line pattern step 710

Displaying the line pattern step 712

Selecting from a logical expression list a logical expression 714

Forming the logical expression with line pattern identifiers 716

Validating event messages in the logical expression step 717

Entering at least one action item to be executed in the event of a “true” evaluation of the line

pattern step 718

Displaying the computer's file system step 720

Navigating the computer's file system step 722

Selecting a file to be monitored step 724

### DETAILED DESCRIPTION

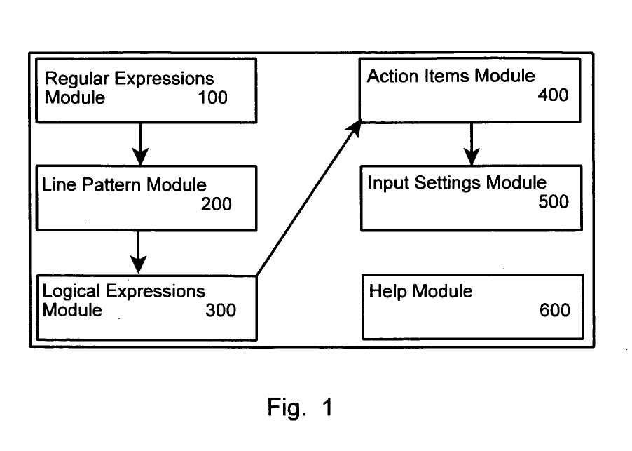

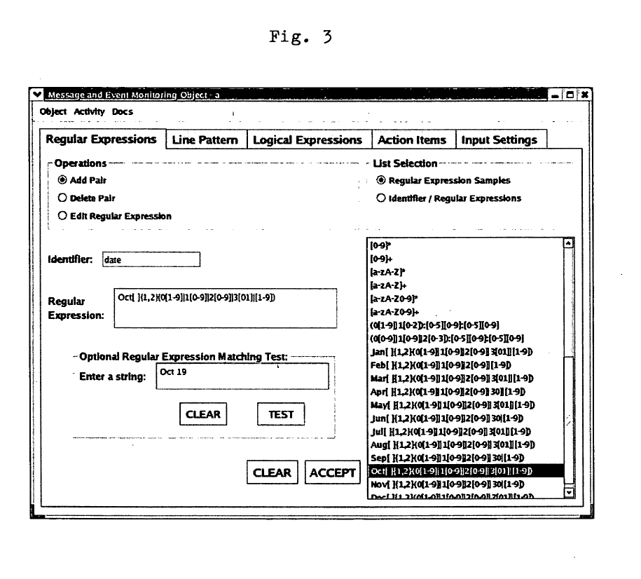

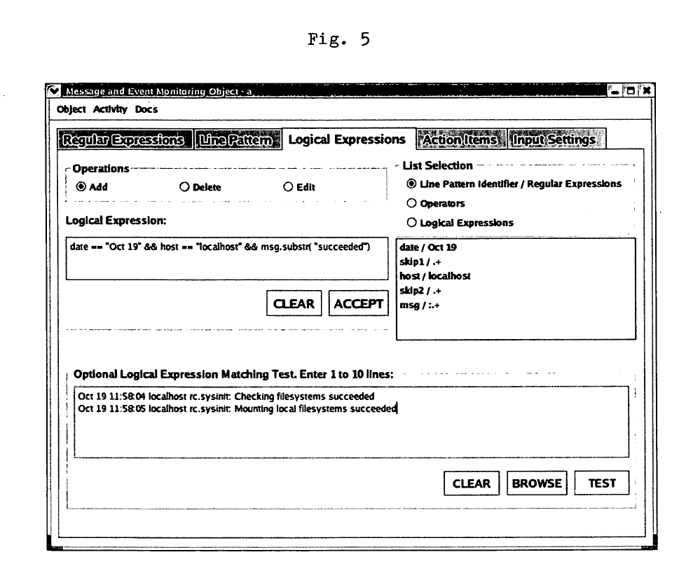

FIG. 1 is a block diagram of the device of the invention. In the presently preferred embodiment and best mode presently contemplated for carrying out the invention, five major functions and thus five major modules are anticipated, with a sixth help module for user assistance. The screen shots of FIGS. 3 through 7 may be considered to be modules, since various modem GUI frame works effectively connect screens to the ensuing actions taken by the computer.

Regular Expressions Module 100, Line Pattern Module 200, Logical Expressions Module 300, Action Items Module 400 and Input Settings Module 500 are the major modules. Help Module 600 is the help module for user assistance, instructions, overviews, discussions of log files, examples and so on.

In steps, the process may consist of:

1. Selecting from a regular expression sample list a regular expression or manually entering it and associating an identifier with the regular expression;

2. Validating a first test string with the selected regular expression;

3. Displaying the selected regular expression with its associated identifier;

4. Ordering of the identifiers into a line pattern;

5. Validating of event messages with the line pattern;

6. Displaying the line pattern;

7. Selecting from a logical expression list a logical expression or manually entering it;

8. Forming one or more logical expressions from a subset of the identifiers in the line pattern;

9. Validating event messages with a logical expression;

10. Entering at least one action item per logical expression to be executed in the event of a “true” logical expression;

11. Displaying the file system;

12. Graphically navigating the file system;

13. Selecting a file to be monitored;

14. Extracting text lines from a selected file.

In general, the word “designation” not only includes the actual designation of an item but includes selection of an item from a list, manual entry of the item and so on.

These steps are initially taken in a sequenced order. That is, identifier/regular expression pairs and line pattern definitions are necessarily done-before logical expressions can be formed. For example in the preferred embodiment, it is not possible to go to the logical expressions module unless a line pattern is provided. If, however, after one or more tab panels are ‘opened’, input enabled, and their inputs have been accepted, any antecedent tab panel may be accessed. The general rule that no tab panel is accessible unless dependent inputs from other tab panels have been defined is strictly enforced. If a change to the antecedent tab is made that adversely affects its succeeding tab panel, an error will be reported. Such limitations prevent creation of a flawed monitoring object. These steps are now discussed in more detail.

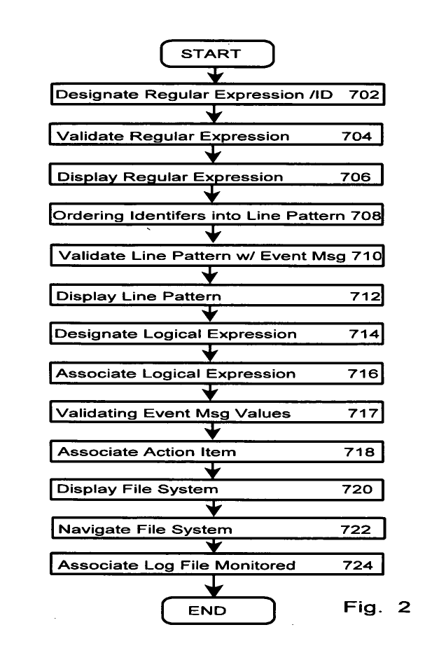

FIG. 2 is a flow chart of the method of the invention. The purpose of the Regular Expression tab panel is to designate a set of one or more regular expressions, define a set of identifiers that are associated with their respective regular expressions and to provide a test facility for the regular expression inputs. Inputs, identifiers and regular expressions alike, may be entered manually or entered by selecting an item from a regular expression sample list (step 702 of the flowchart of FIG. 2). Selecting an identifier/regular expression pair from the Identifier/Regular Expressions list will auto-populate both the identifier and regular expression text boxes. After a regular expression has been associated with an identifier in the Regular Expressions tab panel, only the identifier is allowed to be entered as input on subsequent screens; the regular expression is never directly referenced again. Some examples of regular expressions include numbers [0-9] and uppercase and lowercase letters [a-zA-Z]. The period regular expression (that is: “.”) will match any character. The expression [a-z]+ will match one or more lower case alphabetic characters. Various instances of regular expressions may be formed using parentheses, meta-characters and other standard characters as well. Programmers already normally deal with such regular expressions in various contexts. Each regular expression entered is validated. In the event of an invalid regular expression, an error message will be produced and the user will be re-prompted for input.

As may be seen in FIGS. 3, 4, 5, 6, and 7 and mentioned previously, auto-population of an input text box may occur by selection of an item from a list as in example FIG. 3 in which a long regular expression for dates in June is selected and auto-populated into the regular expression box. Obviously, identifiers and regular expressions may be manually entered as well. In this module in FIG. 3, it may be seen that regular expressions and their identifiers may be added, may be deleted, or edited. An identifier is of course the name given to a regular expression by the programmer. The Add Pair operation/module adds an Identifier/Regular Expression pair to the MEMO instance's regular expression collection. The Delete Pair operation removes an Identifier/Regular Expression pair from the regular expression collection. The Edit Regular Expression operation modifies the regular expression portion of an Identifier/Regular Expression pair.

Table One describes regular expressions used in the presently preferred embodiment of the invention and best mode now contemplated, but is exemplary only.

TABLE ONE
Descriptions of the Regular Expressions List Members Embedded
in the Regular Expression Tab

```
Matches any character.
    .
Zero or more matches of any character.
    .*
One or more matches of any character.
    .+
Matches a double quote.
    \”
Matches a left parenthesis.
    \(
Matches a right parenthesis.
    \)
Matches a tab.
    \t
Matches a newline.
    \n
Matches left and right parenthesis, enclosing zero or more characters.
    \(.*\)
Matches left and right parenthesis, enclosing one or more characters.
    \(.+\)
Matches one or more tab or white space characters.
    [\t]+
Matches zero or more lower case alphabet characters.
    [a-z]*
Matches one or more lower case alphabet characters.
    [a-z]+
Matches zero or more upper case alphabet characters.
    [A-Z]*
Matches one or more upper case alphabet characters.
    [A-Z]+
Matches zero or more number characters.
    [0-9]*
Matches one or more number characters.
    [0-9]+
Matches zero or more, lower or upper case alphabet characters.
    [a-zA-Z]*
Matches one or more, lower or upper case alphabet characters.
    [a-zA-Z]+
Matches zero or more, lower or upper case alphabet characters or number
characters.
    [a-zA-Z0-9]*
Matches one or more, lower or upper case alphabet characters or number
characters.
    [a-zA-Z0-9]+
Matches hour, minute, second.
    (0[1-9]|1[0-2]):[0-5][0-9]:[0-5][0-9]
Matches military hour, minute, second.
    (0[0-9]|1[0-9]|2[0-3]):[0-5][0-9]:[0-5][0-9]
Matches abbreviated month and day.
    Jan (0[1-9]|1[0-9]|2[0-9]|3[01])
    Feb (0[1-9]|1[0-9]|2[0-9])
    Mar (0[1-9]|1[0-9]|2[0-9]|3[01])
    Apr (0[1-9]|1[0-9]|2[0-9]|30)
    May (0[1-9]|1[0-9]|2[0-9]|3[01])
    Jun (0[1-9]|1[0-9]|2[0-9]|30)
    Jul (0[1-9]|1[0-9]|2[0-9]|3[01])
    Aug (0[1-9]|1[0-9]|2[0-9]|3[01])
    Sep (0[1-9]|1[0-9]|2[0-9]|30)
    Oct (0[1-9]|1[0-9]|2[0-9]|3[01])
    Nov (0[1-9]|1[0-9]|2[0-9]|30)
    Dec (0[1-9]|1[0-9]|2[0-9]|3[01])
End of Table One
```

Rules of grammar for logical expressions and the content, selection and descriptions of regular expressions embedded in the Regular Expressions Tab/module may vary: while the preferred embodiment has a fixed logical grammar and regular expression content, it is possible that these may change without departing the scope of the application.

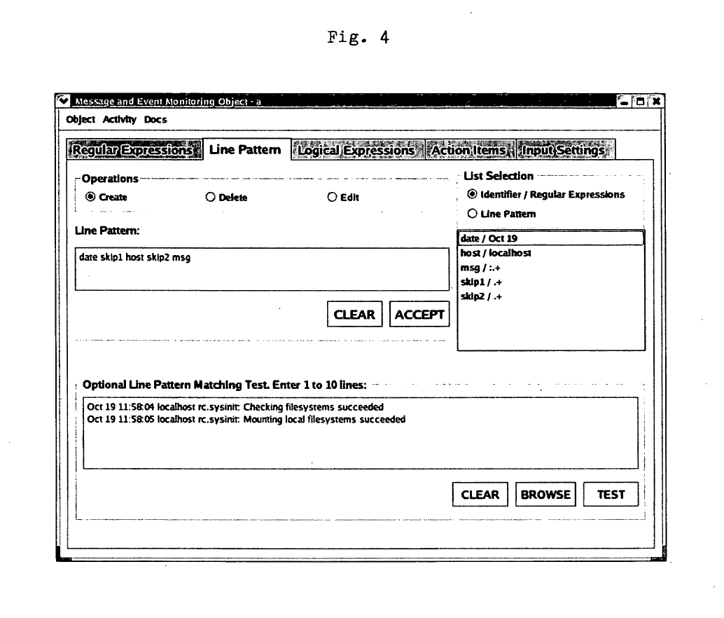

Similarly, in FIG. 4 a list of identifiers and their associated regular expressions (previously selected in the module of FIG. 3) are displayed. They may be populated into their respective input boxes via list selection or manually entered in the input box.

Validating of a first test string with the selected regular expression, step 704 of FIG. 2, consists of entering one or more test strings, which are then compared to the regular expression for a match. For example, a test string of 123 will fail the regular expression [a-z]+, but the string “ben” will pass. As with all of the modules of the present invention, text may be input, lists may allow selection therefrom, and file structures used on the computer may be graphically navigated and selected from.

The present invention embodies support for the creation of a single line pattern. Alternative embodiments may include an action item of replacing the current line pattern with another. In embodiments, the device may support a single line pattern or it may allow support of multiple line patterns. Displaying the identifier/regular expressions pairs on the tab panels succeeding the Regular Expressions tab panel allows the user to track what they have done; thus step 706 is necessary to convenient programming, and this display may be seen in FIG. 4, in which the “Line Pattern” tab has been selected. In particular, the task of ordering of the identifiers, which denote the regular expressions, into a line pattern taught as step 708 is manageable because the identifiers and their associated regular expressions are shown to the user on line pattern tab panel. Ordering may occur during step 702 by a chosen sequence. Thus in the preferred embodiments, the selected identifiers and their associated regular expressions are displayed on a list, and the identifiers are ordered by the user in the desired sequence in the line pattern text input box.

Validating of ten or less sample messages with the line pattern at step 710 of FIG. 2 of the flowchart may also be seen in FIG. 4, in which optional line pattern matching test entries have been made and allow a test to be run merely by activating the push button marked TEST. Obviously, there is not limitation to ten or less sample messages in alternative embodiments of the invention, and even a single validation may fall within the scope of the invention.

The purpose of the logical expressions tab is to form and to evaluate logical expressions in a test mode. Displaying the line pattern step 712, selecting from a logical expression list a logical expression step 714 and forming the logical expression with line pattern identifiers step 716 depict this step.

Multiple logical expressions are permitted and each can be tested. Inputs like identifiers and operators may be entered manually or be entered by being selected from a list, which results in the list item directly copied to the logical expression text input box with a space before it, placed in a left to right sequence. Several logical expressions may exist. A previously entered logical expression may be selected from a logical expression list thereby auto-populating the logical expression text input box, which saves typing when edit or delete operations are performed. In addition to identifiers, logical expressions encompass such well known operators as═, !=, >, <, ∥ and &&. Programmers are accustomed to use of such items as the logical OR “∥” and the logical AND “&&” and thus working with these when presented in a logical and cohesive format, even in a new context of log file monitoring, does not present a challenge. The possible form of a valid logical expression is governed by a grammar. An invalid logical expression is immediately detected and reported.

Table Two summarizes the logical grammar used in the present invention's preferred embodiment. Obviously, this is exemplary only.

TABLE TWO

The Grammatical Components of the MEMO Logical

Expression

Lexical specification using Lex syntax:

Lex token definitions -

%token <sval> STRING
%token <sval> IDENTIFIER
%token SUBSTR
%token NOTSUBSTR
%token LE GE EQ NE
%token LAND LOR
%token NL
%token NUL
%token OTHER /* the garbage token */
%type <bval> expression
%type <bval> stringexpr
%type <bval> binary
%left LOR
%left LAND
%left LE NE
%left “<” “>”

Associated Lexical Patterns -

| | |
|---|---|
| NOTSUBSTR | (\.notsubstr) |
| SUBSTR | (\.substr) |
| STRING | \“([\hat{ }”]*)\” |
| IDENTIFIER | [A-Za-z]([a-zA-Z_0-9]){0,9} |
| EQ | “==” |
| NE | “!=” |
| ‘(‘ | “(” |
| ‘)’ | “)” |
| ‘<. | “<” |
| ‘>’ | “>” |
| LAND | “&&” |
| LOR | “\|\|” |
| [ \t]+ | |
| NL | “\n” |
| NUL | “\0” |
| OTHER | . /* the garbage catch all */ |

Grammatical specification in Backus Naur form:

| Expression | -> | stringexpr |
|---|---|---|
| | \| | |
| | | error |
| stringexpr | -> | stringexpr LAND stringexpr /* && */ |

| \| | |
|---|---|
| | stringexpr LOR stringexpr /* \|\| */ |
| \| | binary |

| ; | |
|---|---|
| binary -> | IDENTIFIER ‘<’ STRING |

| | |
|---|---|
| \| | |
| | IDENTIFIER ‘>’ STRING |
| \| | |
| | IDENTIFIER EQ STRING /* == */ |
| \| | |
| | IDENTIFIER NE STRING /*!= */ |
| \| | |
| | IDENTIFIER SUBSTR ‘(’ STRING ‘)’ |
| \| | |
| | IDENTIFIER NOTSUBSTR ‘(’ STRING ‘)’ |
| \| | |
| | ‘(’ stringexpr ‘)’ |
| ; | |

End of Table Two

For example, if we suppose a log file consisting entirely of dates, a very simple line pattern such as date with an underlying regular expression of Feb([01][0-9]2[0-8])(02) may be the basis for several different logical expressions: date═“Feb 11 02”, date>“Feb 12 02” and others. In operation, a logical expression will return a value of “true” or “false” upon evaluation of a line in the log or file.

Thus, there are two levels of matching at this stage: the first, the line pattern which is a concatenation of the regular expressions of the identifiers that comprise it acts as a course filter looking at the format of the message to validate that the proper character groups have been detected, and then as a second level of matching, the logical expression looking within the whole or a subset of the character groups for specific values. Thus, the text line “Feb 01 02” may match the line pattern whose sole member is date, but fall outside the range of values (in an example, date═“Feb 29 02”) as specified by a logical expression.

Other operations may be carried out on the regular expressions and logical expressions. Thus the various modules of the invention may include a regular expression add utility, a regular expression deletion utility, a regular expression editing utility; an identifier deletion utility; a logical expression deletion utility; a logical expression editing utility, a line pattern add utility, a line pattern deletion utility, a line pattern edit utility, an action item addition utility, an action item deletion utility, and an action item edit utility, and combinations thereof. These allow editing within a regular expression or logical expression, deletion of them and so on.

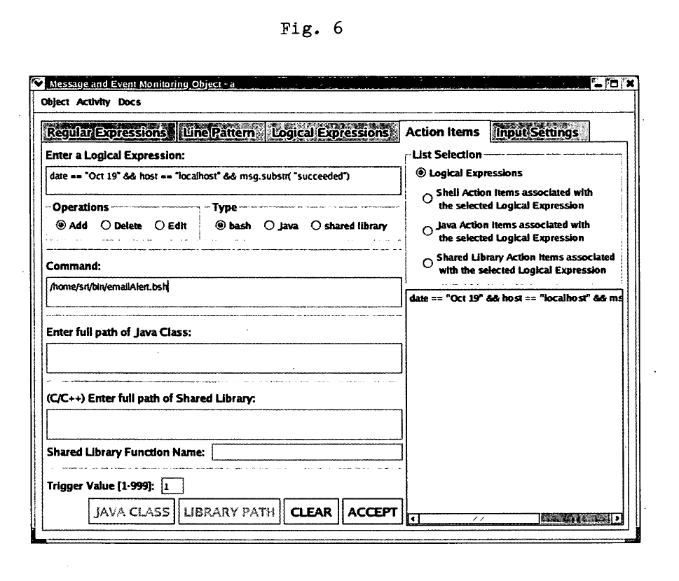

Step 718 consists of entering at least one action item to be executed in the event of a evaluation of a logical expression to “true”. This step, the module for which is displayed at FIG. 6, various options for the type of actions to be triggered are presented: commands (many of which are shell scripts), Java applications, and C/C++ shared library functions all may be activated. In the case of commands, once this level of programming capability has been accessed, an extremely wide range of actions may in turn be initiated, including emails, paging alerts, faxes and other telephony messaging, database transactions and combinations thereof. Known systems do not present easy self-testing techniques taught above, do not present integrated development environments dedicated to this specific type of object (log monitor instances), and so on.

While prior art matching of regular expressions may be known in the field, it is believed to be entirely novel to encapsulate the functionalities of line pattern matching, logical expression evaluation, and action response invocation within a single object, and novel to provide a programming environment allowing that encapsulation.

While example herein shows a single logical expression to satisfied, and a single action to be taken, multiple logical expressions each having its own action item set may be carried out in a single instance. In other words, multiple action items may be initiated by a single object. Providing for multiple logical expressions is necessary, because different portions of a message may be of interest to distinct audiences, and require different action items to be associated with that logical expression.

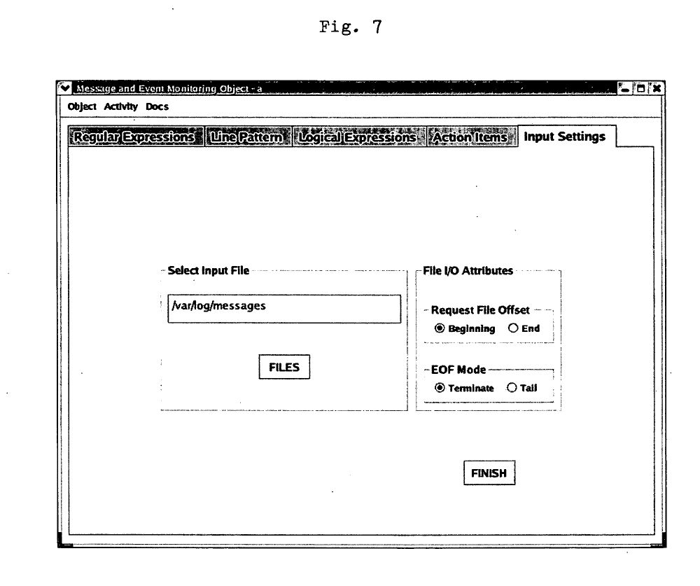

FIG. 7 and step 720, 722 and 724 show the steps of displaying the computer's file system, including the possibility of graphically navigating the computer's file system (the commonest example of this is the WINDOWS EXPLORER function) and thus selecting a file to be monitored. This step of designating the log file may be carried out by graphical navigation of the computer's file structure/system or by manual entry of a file path. Alternative embodiments include selection from a list or menu and so on.

In a real production environment, log files are typically rotated, usually to prevent large, unwieldy files. Log rotation involves: copying the file and renaming it, then truncating the original file after which logging re-commences. Because the invention has been hardened for log rotation, no user action or intervention is necessary.

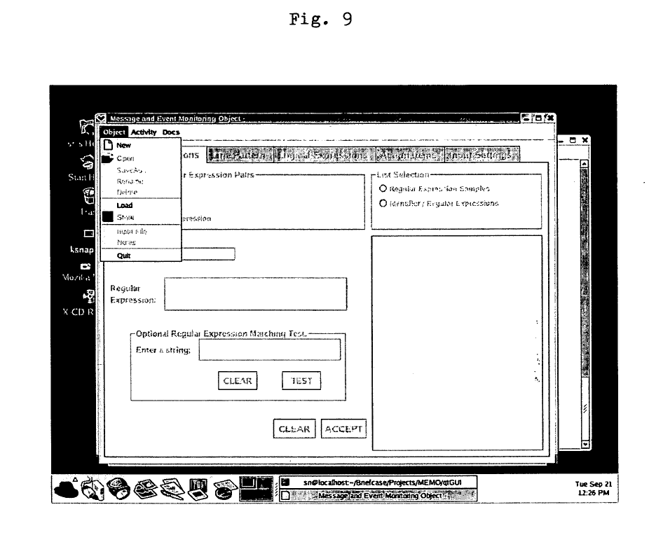

The device of the invention may include modules allowing saving of the object created and resumption of work, or modification of the object instance at a later date. This also allows transfer of objects from user to user permitting modification, copying and the like. For example, the “OBJECT” menu which may be seen in FIGS. 3 through 7, when pulled down, shows options such as “NEW”, “OPEN”, “SAVE AS”, “RENAME”, “DELETE”, “LOAD”, “STORE” and the like: FIG. 9 is a screen shot of a menu in use in the invention. These allow file level manipulation of the objects created by means of the invention. The GUI/IDE of the invention allows saving of useful objects for later copying, modification, and so on. A more detailed description of the OBJECT menu items follows:

The New dialog prompts for an instance name. If the name input passes validation, an empty MEMO instance is created, and the Regular Expression Tab panel, the first of five tab panels, is opened for input.

The Open dialog displays a list view of MEMO instances with status information about each list member with regard to being complete, which means all necessary inputs have been rendered. Double clicking on an instance's name in this list will bring the instance into the invention's work space, overwriting the residing instance and displaying the tab panel that was selected when the instance was last accessed. Pressing the dialog's RETURN push button exits the dialog.

SaveAs copies the MEMO instance residing in the work space to a new instance and resets its name.

The Rename dialog displays a list view of MEMO instances with status information about each list member with regard to being complete. Double clicking on a name in this list will invoke a name dialog box that prompts the user for a new instance name. An instance cannot be re-named if it is running. Pressing the dialog's RETURN push button exits the dialog.

The Delete dialog displays a list view of MEMO instances with status information about each list member with regard to being complete. Double clicking on an instance's name in this list will remove that instance from the invention's work space. An instance cannot be deleted if it is running. Pressing the dialog's RETURN push button exits the dialog.

Load reconstructs one or more MEMO instances from ‘.MEMO’ files. Multiple files from the same directory may be selected either by single clicking on the icon while depressing the CRTL key, or by manually typing a list of file names, each enclosed in double quotes and each separated by white space. If the instance reconstruction is successful, then it is added to invention's internal table. First, a file dialog prompts the user for a file name, which may be entered either by typing a complete file name path or by graphically navigating a series of directory icons to build a file path incrementally until the desired directory has been selected, after which a file is selected by a single click of its icon or by manually entering a file name enclosed within double quotes. The chosen path must end in a ‘.MEMO’ file extension; otherwise an error message will appear. If while attempting to load an instance whose name conflicts with an instance name already present in the work space, then the instance will be loaded into the work space and re-named ‘unnamed’ to avoid a duplication. The user should later select the Rename pull-down menu item (Object menu) to invoke a dialog that will re-name the ‘unnamed’ instance. The Loading of an instance will not supplant the instance that is resident in the work space. If, however, invention's internal table is empty at the time of the Load, then the newly loaded instance will occupy the work space and also will be added to the table. It should be noted that the invention preserves the state of its instances. That is, when an instance is loaded into the work space, it displays the tab panel that had been selected at the time the instance was stored to file. For example, if the user ‘Store’s the instance while in the Input Settings tab panel, then that tab panel, will be displayed when the instance is again ‘Load’ed into the work space.

Store serializes a MEMO instance in a machine independent format to a file. The user is prompted to choose a candidate from the entries in invention's work space. A file dialog then follows. A complete file path may be typed into the dialog directly or the file path may be incrementally specified by graphical navigation of the file system, after which a file name may be entered into the input dialog box. The name of the file will have a ‘.MEMO’ extension added to it automatically if the user has not explicitly entered it.

A MEMO instance gets its input from a log file or from any other file that is readable by the user. If the user does not have read permission for the file, then an error message will be displayed.

Selecting the Input File pull-down menu item (Object menu) invokes an Input File dialog. The user may specify an input file either by typing the complete file path into the file dialog or by graphically navigating a series of directory icons to build a file path incrementally until the desired directory has been selected, after which a file is selected by a single click of its icon. (A double clicking on a directory entry displays its contents. A single click selects a particular file. Double clicking on a file immediately ends the dialog.) The file must have the proper read permissions, otherwise an error will occur.

The Notes dialog spawns a notepad for entering unformatted text. The CLEAR push button clears all text input. Pressing the SAVE push button saves the text for future viewing, and then returns from the dialog. Pressing the CANCEL push button exits the dialog discarding the input.

QUIT is a self explanatory menu option.

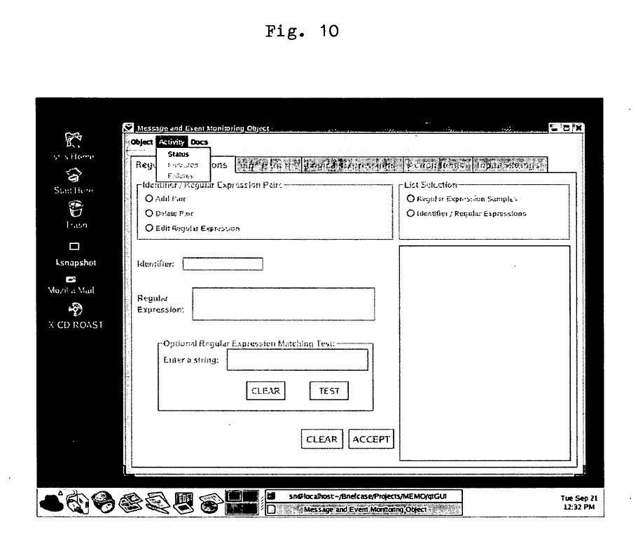

FIG. 10 shows the “ACTIVITY” menu, having three entries thereon: “STATUS”, “RUN/STOP”, and “FAILURES”. A more detailed description of the ACTIVITY menu items follows.

The Status dialog indicates if the instance is running or stopped and if it is complete or incomplete, an indication of whether all necessary inputs have been rendered. The Complete column displays either Yes or No. An incomplete MEMO instance does not have all its attributes defined; thus, it is not run able and it will always have a status of stopped. To track instance states, press the REFRESH push button, which snap-shots instance activity. Pressing the RETURN push button ends this dialog.

The Run/Stop dialog starts or stops the execution of a MEMO instance. The user may select a single instance by double clicking on the name. If the user presses the SHIFT key after single clicking on an item, then all the items between the current item and the clicked item get selected. The SHIFT key must be held while the mouse is double clicked, causing the instances to toggle their run state. The pressing of the Ctrl key when clicking on an item de-selects the item. To start instance execution, view the Idle list and then double click on the desired instance name entry on the selected list. Similarly, to stop execution, view the Running list and then double click on the desired instance name entry or selected list. That is, instances toggle from idle to running or from running to idle. To monitor the status of an instance press the Status pull-down menu (Activity menu). Pressing the RETURN push button ends this dialog.

The Failures dialog tracks the number of action items that failed to execute or that yielded a non-zero return code. No action item specific information is kept. Pressing the RESET push button will set the failure count to zero. This alerts users to instances which may not run reliably and thus helps prevent the circumstance that a programmer believes actions are being taken when in fact they are not.

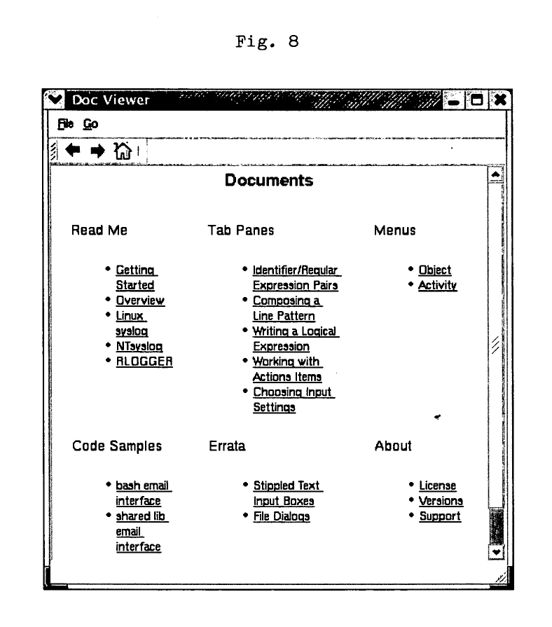

FIG. 8 is a screen shot of a sixth help module of the invention. Various options to assist in understanding of the device and method of the invention are included. This specifically includes explanations of each of the menu items and tab panels with regard to function and operation, action item code sample examples, and license, version and support information.

In an alternative embodiment, it could be seen that the logical structures of the invention allow the objects created therewith to actually hunt for a sequence of event messages. That is, finding a message matched by the line pattern and evaluated as true by a logical expression may then have the action item response of installing a new line pattern thus beginning the next evaluation with a different line pattern. A properly programmed sequence of line patterns can be used to actually trace the type of “cascade” of errors and ensuing messages which so often occur in computer applications.

While the modules are presented in a logical order, and the steps of the method of the invention are presented in that logical order, it will be appreciated that users may recur to previous modules that are input enabled to add, change or edit the attributes offered by that module and so on. Thus, the Logical Expressions tab panel may be accessed repeatedly during the object creation process if necessary, as may all others that have been previously accessed, merely by selecting that module by means of a tab.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

1. A log monitoring software object creation integrated development device for use on a computer having a file system, the device comprising:
i) a regular expression designation module having a regular expression sample list and a first utility allowing designation of at least one regular expression, and having a first test module allowing validation of a first test string with the selected regular expression;
ii) a line pattern module having a display of the selected regular expressions and having a second utility allowing designation of the selected regular expressions into a line pattern, and having a second test module allowing validation of a first test message with the line pattern;
iii) a logical expression designation module having a sample logical expression list and a display of the line pattern elements, and having a second utility allowing association of at least one logical expression to examine at least one regular expression in the line pattern, and having a third test module allowing validation of a message with the logical expression.

2. The log monitoring software object creation device of claim 1, further comprising:
iv) an action item designation module having an entry form allowing users to enter at least one action item to be activated upon return of a logical value by the logical expression.

3. The log monitoring software object device of claim 2, wherein the at least one action item further comprises one member selected from the group consisting of: executable objects, Java applications, C/C++ shared library functions, other shared object libraries, email software, paging devices, telephony devices, database transactions and combinations thereof.

4. The log monitoring software object creation device of claim 1, further comprising:
v) an input settings module displaying the computer's file system and allowing user navigation of the computer's file system and allowing user designation of a file to be monitored.

5. The log monitoring software object creation device of claim 4, wherein the step v) further comprises: allowing selecting of monitoring of the file to be monitored from its beginning.

6. The log monitoring software object creation device of claim 5, wherein the step v) further comprises: allowing selecting of monitoring of the file to be monitored from its end.

7. The log monitoring software object creation device of claim 4, wherein the step v) further comprises: selecting monitoring of the file to be monitored to terminate when an end of file is encountered.

8. The log monitoring software object creation device of claim 7, wherein the recurrent monitoring consists of tailing the file.

9. The log monitoring software object creation device of claim 1, further comprising a help module offering users one member selected from the group consisting of: samples of code for log monitoring software objects, explanations, action item codes samples and combinations thereof.

10. The log monitoring software object creation device of claim 1, wherein at least one selected regular expression has associated therewith an identifier, and further wherein use of the identifier in a line pattern operates as use of the regular expression associated therewith.

11. The log monitoring software object creation device of claim 1, further comprising one utility selected from the group consisting of: a regular expression add utility, a regular expression deletion utility, a regular expression editing utility; an identifier deletion utility; a logical expression deletion utility; a logical expression editing utility, a line pattern add utility, a line pattern deletion utility, a line pattern edit utility, an action item addition utility, an action item deletion utility, and an action item edit utility, and combinations thereof.

12. A method of programming a log monitoring software object comprising:
i) designating at least one regular expression;
ii) displaying the selected regular expression;
iii) ordering of the selected regular expression into a line pattern;
iv) displaying the line pattern;
v) designating at least one logical expression;
vi) associating the logical expression with at least one selected regular expression;
vii) entering at least one action item to be invoked in the event of a “true” return of the logical expression; and
viii) designating a file to be monitored.

13. The log monitoring software object creation method of claim 12, wherein the at least one action item further comprises one member selected from the group consisting of: executable objects, Java applications, C/C++ shared library functions, other shared object libraries, scripts, email scripts and software, paging alerts, telephony devices, database transactions and combinations thereof.

14. The log monitoring software object creation method of claim 12, further comprising one member selected from the group of steps consisting of:
i-b) selecting the regular expression from a list;
i-c) manually entering the regular expression; and
i-d) combinations thereof.

15. The log monitoring software object creation method of claim 12, further comprising one member selected from the group of steps consisting of:
ii-b) validating a first test string with the regular expression;
iv-b) validating a first test message with the line pattern;
vi-b) validating a message with the logical expression;
and combinations thereof.

16. The log monitoring software object creation method of claim 12, further comprising one member selected from the group of steps consisting of:
vi-b) displaying the computer's file system; and
vi-c) navigating the computer's file system.

17. The log monitoring software object creation method of claim 12, further comprising one member selected from the group of steps consisting of:
vii-b) displaying the computer's file system; and
vii-c) navigating the computer's file system.
